(19) United States
(12) Patent Application Publication
(10) Pub. No.: US 2005/0109193 A1
(43) Pub. Date: May 26, 2005

(54) Method and apparatus for practicing music

(76) Inventor: Marcus Harlowe Wolfe, Chicago, IL (US)

Correspondence Address: WILDMAN HARROLD ALLEN & DIXON, 225 WEST WACKER DRIVE, SUITE 2800, CHICAGO, IL, 60606, US

(21) Appl. No.: 10/722,803

(22) Filed: Nov. 26, 2003

(51) Int. Cl. G09B 15/00

(52) U.S. Cl. 84/470 R

(57) ABSTRACT

A method and an apparatus for practicing music. A user utilizes the apparatus to generate notation representative of at least one set of musical tones. The user then produces at least one set of musical tones in response to random generation of the notation.

### FIELD OF THE INVENTION

The present invention relates to music, and more specifically to an apparatuses and methods for practicing music.

### BACKGROUND OF THE INVENTION

For musicians, practicing music can be a repetitive and tedious process. This is especially true when it comes to practicing the basic musical scales. When practicing scales, musicians often mind-numbingly play and repeat predetermined sequences of scales from a music book. Often musicians' minds wander during this process and they have to repeat the scale to insure that they played them properly. Moreover, because the repetitive nature of the practice bores the musicians, their minds and reflexes do not efficiently absorb the practice. Therefore, what is needed a way of practicing music that engages a musician's attention in such a manner that practice time is utilized more efficiently than by playing and repeating predetermined sequences of the scales.

### BRIEF SUMMARY OF THE INVENTION

In one example, a method is provided. Notation representative of at least one set of musical tones is randomly generated. The at least one set of musical tones is produced in response to random generation of the notation.

In another example, a system is provided. The system includes means for randomly generating notation representative of at least one set of musical tones and means for producing the at least one set of musical tones in response to random generation of the notation.

In a further example, an apparatus is provided. The apparatus comprises a die having musical notation positioned on at least one of its faces.

### BRIEF DESCRIPTION OF THE DRAWING

The forgoing aspects and many of the advantages of the present invention will become readily appreciated by reference to the following detailed description, when taken in conjunction with the accompanying drawings, wherein:

FIG. 1 is one example of an eight sided die used to randomly generate a type of scale;

FIG. 2 depicts exemplary notation, representing different types of scales, that is positioned on the respective faces of the die of FIG. 1;

FIG. 3 is an exemplary embodiment of a twelve-sided die used to randomly generate a key of a scale;

FIG. 4 depicts exemplary notation, representing keys of scales, that is positioned on the respective faces of the die of FIG. 3;

FIG. 5 is an exemplary embodiment of an eight-sided die used to randomly generate a mode of a scale;

FIG. 6 is an illustrative diagram depicting exemplary notation, representative of modes of scales, that is positioned on the respective faces of the eight-sided die of FIG. 5;

FIG. 7 is an exemplary embodiment of a six-sided die used to randomly generate a permutation of a scale;

FIG. 8a is an illustrative diagram depicting one example of notation of the permutations of scales that can be positioned on the six-sided die of FIG. 7;

FIG. 8b is an illustrative diagram depicting another example of notation of the permutations of scales that can be positioned on the six-sided die of FIG. 7; and

FIG. 8c is an illustrative diagram depicting still another example of notation of the permutations of scales that are can be positioned on the six-sided die of FIG. 7.

### DETAILED DESCRIPTION OF THE INVENTION

For a better understanding of the present application, reference may be had to the following detailed description in conjunction with the accompanying drawings.

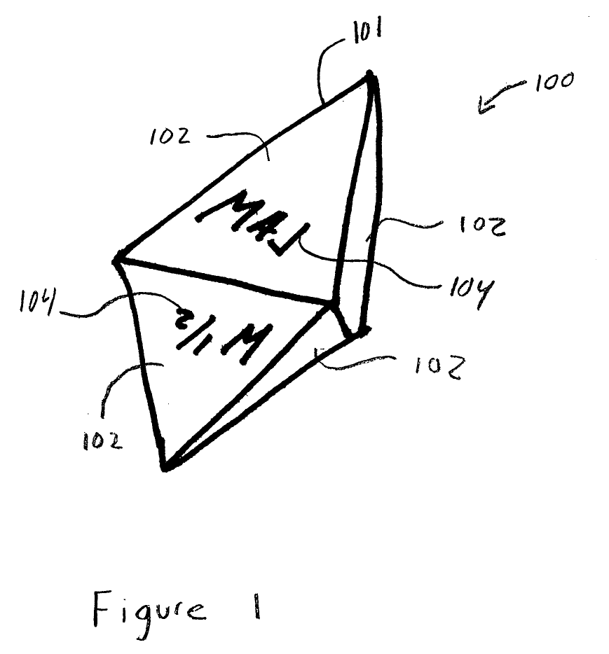

FIG. 1 depicts an apparatus 100 for randomly generating notation. In one example, the apparatus comprises a die 101 having eight faces 102 or sides. Each side 102 has notation 104 positioned thereon that is representative of a type of musical scale. Notation 104 is positioned on sides 102 through any known means, such as writing, pasting, engraving, etc.

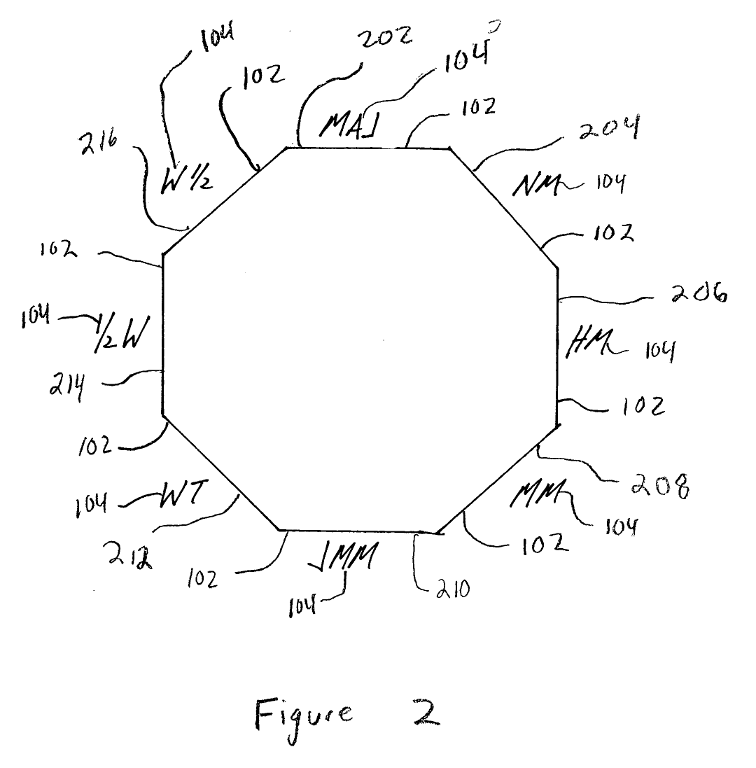

FIG. 2 depicts exemplary notation representative of the types of musical scales that is positioned on die 101. For example, side 202 includes the notation “MAJ”, which is representative of a major scale; side 204 includes the notation “NM”, which is representative of a natural minor scale; side 206 includes the notation “HM”, which is representative of a harmonic minor scale; side 208 includes the notation “MM”, which is representative of a melodic minor scale; side 210 includes the notation “JMM”, which is representative of a jazz melodic minor scale; side 212 includes the notation “WT”, which is representative of a whole tone scale; side 214 includes the notation “½W”, which is representative of a half-whole diminished scale; and side 216 includes the notation W½, which is representative of a whole-half diminished scale. It should be noted that FIG. 2 is not meant to limit the invention to the notation depicted. Alternate forms of notation, such as colors or pictures, could be used to represent types of musical scales.

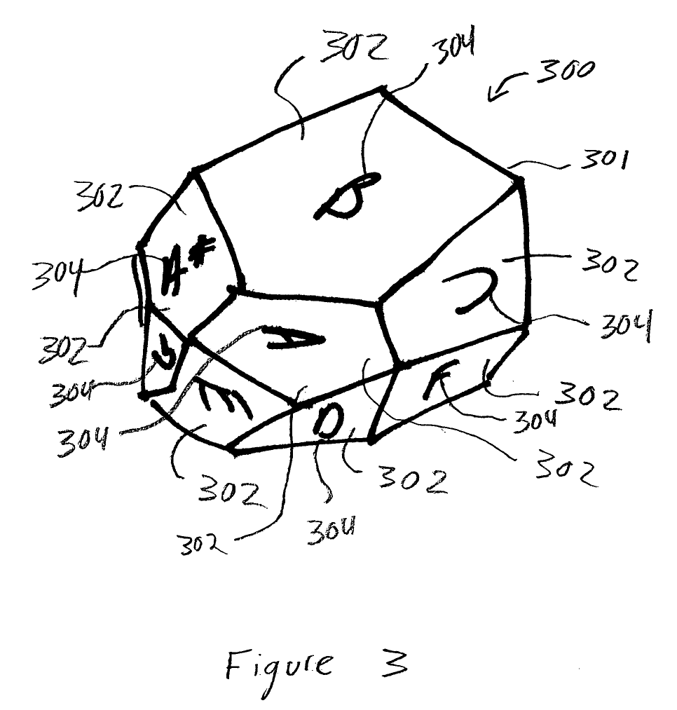

FIG. 3 depicts another example of an apparatus 300 for randomly generating musical notation. In one example, apparatus 300 comprises a die 301 having twelve faces 302 or sides. Each face 302 has notation 304 representative of one of the twelve keys of musical scales. Once again, notation 304 is positioned on sides 302 through any known means, such as writing, pasting, engraving, etc.

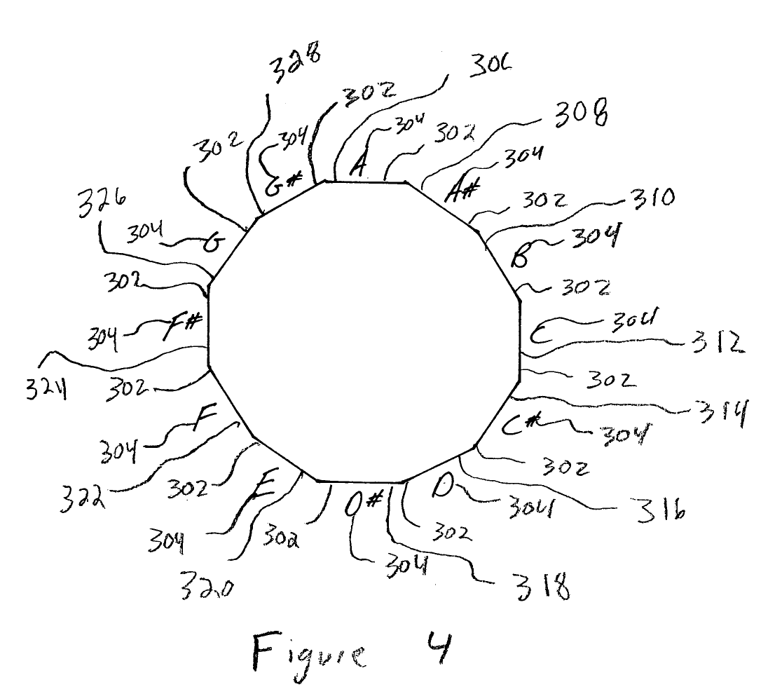

FIG. 4 depicts exemplary notation 304representative of the keys of musical scales that are positioned on the sides 302 of the die 301 of FIG. 3. For example, side 306 includes the notation “A”; side 308 includes the notation A#; side 310 includes the notation “B”; side 310 includes the notation “C”; side 312 includes the notation “C”; side 314 includes the notation C#; side 316 includes the notation D; side 318 includes the notation D#; side 320 includes the notation “E”; side 322 includes the notation “F”; side 324 includes the notation F#; side 326 includes the notation G; and side 326 includes the notation “G#”. It should be noted that FIG. 4 is not meant to limit the invention to the notation depicted. Alternate forms of notation, such as colors or pictures, could be used to represent keys.

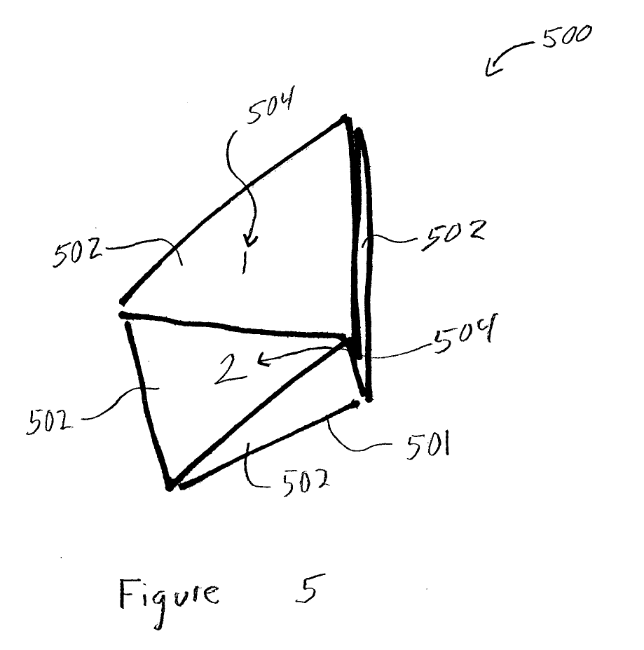

FIG. 5 depicts another example of an apparatus 500 for randomly generating notation. In one example, the apparatus 500 is a die 501 having eight faces 502 or sides. Notation 504 is positioned on the respective faces 502 of the die, which is representative of different modes of musical scales. Once again, notation 504 is positioned on sides 502 through any known means, such as writing, pasting, engraving, branding, etc.

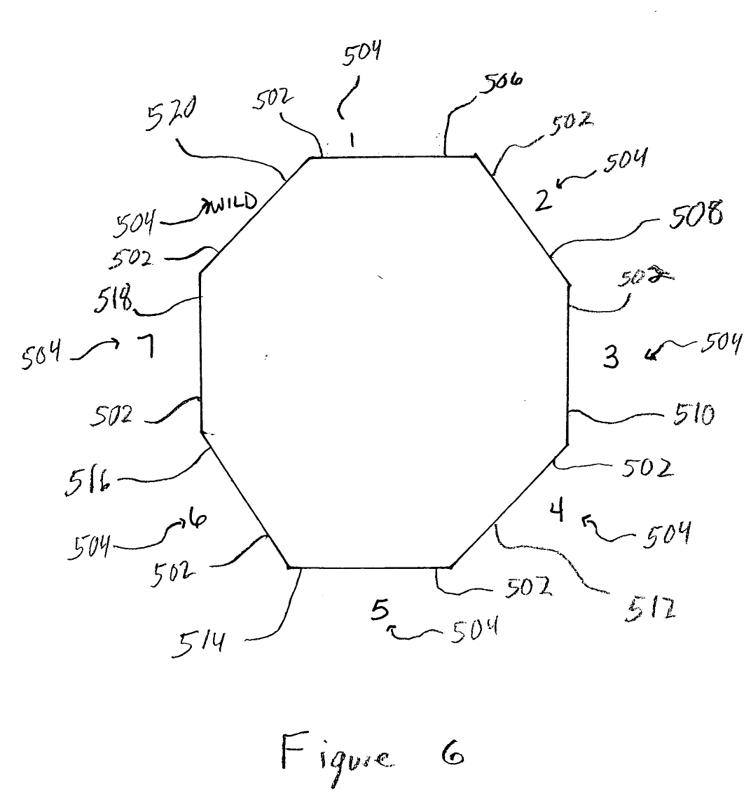

FIG. 6 depicts exemplary notation 504 that is positioned on the respective faces 502 of the die 501 of FIG. 5. For example, side 506 includes the notation “1”; side 508 includes the notation “2”; side 510 includes the notation “3”; side 512 includes the notation “4”; side 514 includes the notation “5”; side 516 includes the notation “6”; side 518 includes the notation “7”; and side 520 includes the notation “wild”. The designation “wild” on side 520 allows the user to choose any one of modes 1-7 when the die lands with side 520 facing up.

In an alternative embodiment, side 506 includes the notation “Ionian”; side 508 includes the notation “Dorian”; side 510 includes the notation “Phygian”; side 512 includes the notation “Lydian”; side 514 includes the notation “Mixo-Lydian”; side 516 includes the notation Aeolian; side 518 includes the notation “Locrian”; and side 520 includes the notation “wild”. It should be noted, however, that these modes are only compatible with the major scale type. Accordingly, this alternative embodiment can not be utilized with apparatus 100 because the scale type can only be major. Therefore, it is necessary to randomly generate a scale type. Moreover, the user would not be able to play a randomly generated scale type, other than major, with the modes listed under the alternative embodiment of die 501. It should be noted that FIG. 6 is not meant to limit the invention to the notation depicted. Alternate forms of notation, such as colors or pictures, could be used to represent mode.

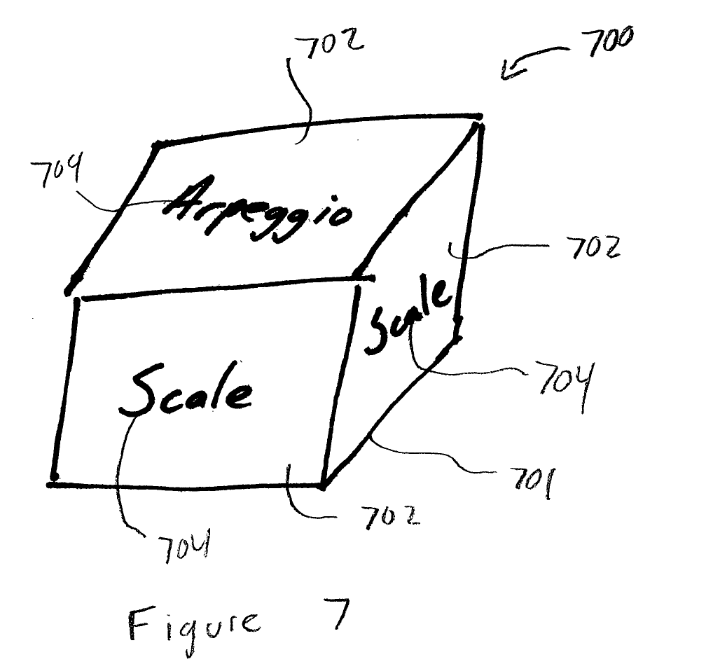

FIG. 7 depicts another example of an apparatus 700 for randomly generating musical notation. In one embodiment, the apparatus comprises a die 701 having six faces 702 or sides. Musical notation 704 is positioned on the respective faces 702 of the die 701. Musical notation 704 is representative of different permutations of musical scales. Once again notation 704 is positioned on die 701 through any known means, such as engraving, etching, branding, etc.

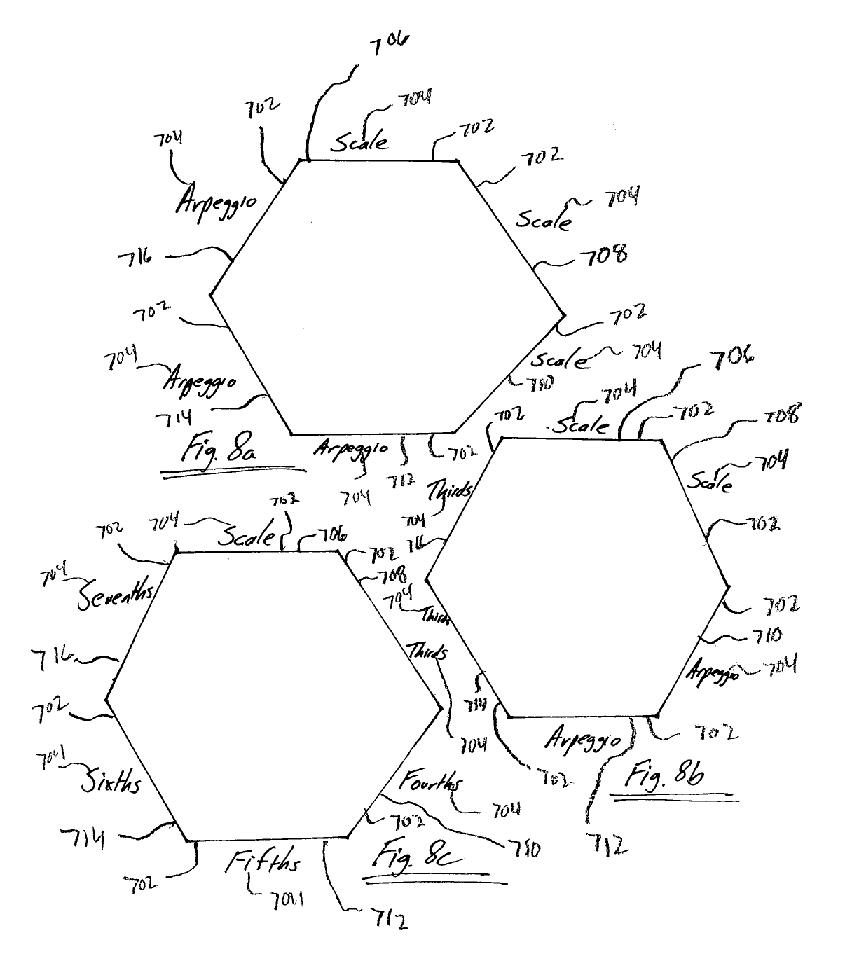

FIGS. 8a, 8b, and 8c, depict exemplary notation which can be positioned on sides 702 of die 801. Any one of the three notation arrangements depicted in 8a, 8b, or 8c can be used with die 801, depending on what the user wishes to practice. For an easier scale, the user may choose to use the notation arrangement depicted in FIG. 8a in which three faces of the six-sided die would be marked with “scale” and the other three faces of the six-sided die would be marked with “arpeggio”. For example, sides 706, 708, and 710 could include notation representative of full scale (“scale”) permutations and sides 712, 714, and 716 include notation representative of arpeggio (“arpeggio”) permutations.

For an intermediate scale, the user may choose to use the notation arrangement depicted in FIG. 8b, which consists of full scale (“scale”), arpeggio (“arpeggio”), and thirds (“thirds”) permutations. In this arrangement, two faces of the six-sided die would be marked with “scale”, another two faces of the six-sided die would be marked with “arpeggio”, and the remaining two faces of the six-sided die would be marked with “thirds”. For example, sides 706 and 708 are marked “scale”; sides 710 and 712 are marked arpeggio; and sides 714 and 716 are marked “thirds”.

Finally, the user may choose to use an advanced notation arrangement, which is depicted in FIG. 8c. This arrangement consists of full scale (“scale”), thirds (“thirds”), fourths (“fourths”), fifths (“fifths”), sixths (“sixths”), and sevenths (“sevenths”) permutations. Each face of the six-sided die would be marked with a different permutation. For example, side 706 is marked “scale” to represent full scale; side 708 is marked “thirds”; side 710 is marked “fourths”; side 712 is marked fifths; side 714 is marked “sixths”; and side 716 is marked “sevenths”.

It should be noted that FIGS. 8a through 8c are not meant to limit the invention to the notation depicted. Alternate forms of notation, such as colors or pictures, could be used to represent permutations. Moreover, different combinations of the permutations on a particular die are envisioned as part of the disclosure.

A detailed description of the use of the apparatuses shown in FIGS. 1 through 8 is now provided for illustrative purposes.

A method of practicing music begins by using any combination of apparatuses 100, 300, 500, 700 to randomly generate musical. When the musical notation is generated a user then produces the tones represented by the musical notation. For example, a user might utilize die 101 and die 301 to produce notation representative of a type of scale and the key of scale. The user individually rolls both the eight-sided die 101 and twelve-sided die 301 to generate the musical notation results. In another example, the user simultaneously rolls the two dice 101 and 301 to generate the musical notation.

If the eight-sided die 101 results in the notation MM and the twelve-sided die 301 results in the notation F#, the user would then produce a melodic minor scale in F sharp. As another example, if the eight-sided die 101 results in the notation ½W and the twelve-sided die 301 results in the notation B, the user would then produce a half-whole diminished scale in B. In one example, the user produces the scale using a musical instrument. In another example, the user produces the scale using another means, such as voice (singing) or digital/electronic musical equipment.

In a further example, apparatus 500 is used, in conjunction with apparatus 100 and apparatus 300, to randomly generate musical notation of the mode of the scale that the user is to produce. The user may roll die 101, die 301, and die 501 individually, or simultaneously. As an illustrative example, the user rolls the three dice 101, 301, and 501. If the eight-sided die 101 resulted in the notation MAJ, the twelve-sided die 301 resulted in the notation D, and the eight-sided die 501 resulted in the notation “4”, the user would then produce a major scale in D in the fourth mode.

In still yet another example, apparatus 700 is used, in conjunction with apparatuses 100, 300 and 500 to randomly generate notation of the permutation of the scale that the user is to produce. The user may roll the dice 101, 301, 501, 701 individually, or may choose to roll the dice simultaneously.

As an illustrative example, the user rolls the four dice 101, 301, 501, and 701 (using the notation arrangement depicted in 8a). If the eight-sided die 101 resulted in the notation WT, the twelve-sided die 301 resulted in the notation A#, the eight-sided die 501 resulted in the notation “1”, and the six-sided die 701 resulted in the notation arpeggio, the user would then produce a whole tone arpeggio in A sharp in the first mode.

As another illustrative example, the user rolls the four dice 101, 301, 501, and 701 (using the notation arrangement depicted in 8b). If the eight-sided die 101 resulted in the notation JMM, the twelve-sided die 301 resulted in the notation G, the eight-sided die 501 resulted in the notation “2”, and the six-sided die 701 resulted in the notation scale, the user would then produce a jazz melodic minor scale in G in the second mode.

As a final illustrative example, the user rolls the four dice 101, 301, 501, 701 (using the notation arrangement depicted in 8c). If the eight-sided die 101 resulted in the notation HM, the twelve-sided die 301 resulted in the notation E, the eight-sided die 501 resulted in the notation “3”, and the six-sided die 701 resulted in the notation sevenths, the user would then produce a harmonic minor seventh in E in the third mode.

In the forgoing specification, the present invention has been described with reference to specific exemplary embodiments thereof. It will be apparent to those skilled in the art that a person understanding this invention may conceive of changes or other embodiments of variations, which use the principles of this invention without departing from the broader spirit or scope of the invention. The specification and drawings are, therefore, to be regarded in an illustrative rather than restrictive sense.

1. A method comprising:
randomly generating notation representative of at least one set of musical tones; and
producing the at least one set of musical tones in response to random generation of the notation.

2. The method of claim 1, wherein the step of randomly generating notation comprises:
rolling at least one die to randomly generate the musical notation.

3. The method of claim 2, wherein the step of rolling comprises:
rolling an eight sided die to randomly generate musical notation representative of a type of scale.

4. The method of claim 2, wherein the step of rolling comprises:
rolling a twelve sided die to randomly generate musical notation representative of a key of a scale.

5. The method of claim 2, wherein the step of rolling comprises:
rolling an eight-sided die to randomly generate musical notation representative of a mode of a scale.

6. The method of claim 2, wherein the step of rolling comprises:
rolling a six-sided die used to randomly generate musical notation representative of a permutation of a scale.

7. The method of claim 2, wherein the step of rolling comprises:
rolling at least two die to randomly generate musical notation that is representative of a combination of at a type of scale and a key of the scale.

8. The method of claim 1, wherein the step of producing the at least one set of musical tones is accomplished by utilization of a musical instrument.

9. A system comprising:
means for randomly generating notation representative of at least one set of musical tones; and
means for producing the at least on set of musical tones in response to the random generation of notation.

10. The system of claim 9, wherein the means for randomly generating comprises at least one die.

11. The system of claim 10, wherein the at least one die comprises:
an eight sided die having musical notation representative of a type of scale positioned thereon.

12. The system of claim 10, wherein the at least one die comprises:
a twelve sided die having musical notation representative of a key of a scale positioned thereon.

13. The system of claim 10, wherein the at least one die comprises:
an eight sided die having musical notation representative of a type of scale positioned thereon.

14. The system of claim 10, wherein the at least one die comprises:
a six sided die representative of a permutation of a scale positioned thereon.

15. The system of claim 10, wherein the at least one die comprises:
an eight sided die having musical notation representative of a type of scale positioned thereon; and
a twelve sided die having musical notation representative of a key of a scale positioned thereon.

16. An apparatus comprising:
a die having musical notation positioned on one of its faces.

17. The apparatus of claim 16, wherein the die has eight faces, each face having notation positioned thereon that represents a type of scale.

18. The apparatus of claim 16, wherein the die has twelve faces, each face having notation positioned thereon that represents a key of the scale.

19. The apparatus of claim 16, wherein the die has eight faces, each face having notation positioned thereon that represents a mode of the scale.

20. The apparatus of claim 16, wherein the die has six faces, each face having notation positioned thereon that represents a permutation of the scale.

21. The apparatus of claim 20 wherein:
three faces of the die have notation indicative of “scale” positioned thereon; and
three faces of the die have notation indicative of “arpeggio” positioned thereon.

22. The apparatus of claim 20, wherein:
two faces of the die have notation indicative of “scale” positioned thereon;
two faces of the die have notation indicative of “arpeggio” positioned thereon; and
two faces of the die have notation indicative of “thirds” positioned thereon.

23. The apparatus of claim 20, wherein:
one face of the die has notation indicative of “scale” positioned on it;
one face of the die has notation indicative of “thirds” positioned on it;
one face of the die has notation indicative of “fourths” positioned on it;
one face of the die has notation indicative of “fifths” positioned on it;
one face of the die has notation indicative of “sixths” positioned on it; and
one face of the die has notation indicative of “sevenths” positioned on it.
